(19) United States
(12) Patent Application Publication
(10) Pub. No.: US 2025/0149714 A1
(43) Pub. Date: May 8, 2025

(54) BATTERY MODULE

(71) Applicant: TOYOTA JIDOSHA KABUSHIKI KAISHA, Aichi-ken (JP)

(72) Inventors: Tomoya MESUDA, Nisshin-shi (JP); Seigo FUJISHIMA, Miyoshi-shi (JP); Yoshiro OBAYASHI, Toyota-shi (JP); Kosuke SUZUKI, Toyota-shi (JP); Takeru HARA, Toyota-shi (JP); Satoshi MORIYAMA, Nagoya-shi (JP); Kenta MIYAHARA, Toyohashi-shi (JP)

(21) Appl. No.: 18/928,183

(22) Filed: Oct. 28, 2024

(30) Foreign Application Priority Data
Nov. 6, 2023 (JP) 2023-189544

(51) Int. Cl. H01M 50/26

(52) U.S. Cl. CPC H01M 50/26; H01M 2220/20

(57) ABSTRACT

A battery module includes: a plurality of battery cells, each battery cell being formed by sealing, with a laminate film, an elongate electrode body; and a case in which the plurality of battery cells are housable in an arrayed state, wherein battery cells that are adjacent are adhered to each other by an adhesive, and wherein an amount of the adhesive differs between lengthwise direction central parts and end parts of the battery cells.

### CROSS-REFERENCE TO RELATED APPLICATION

This application is based on and claims priority under 35 USC 119 from Japanese Patent Application No. 2023-189544, filed on Nov. 6, 2023, the disclosure of which is incorporated by reference herein.

### BACKGROUND

### Technical Field

The present disclosure relates to a battery module.

### Related Art

U.S. Patent Application Publication No. 2018/287184 discloses a battery module in which an electrode assembly is housed in a case. Furthermore, the battery module has a structure where a thermal contractible protection layer surrounds the outside of the electrode assembly, thereby inhibiting thermal expansion of the electrode assembly.

In this connection, using more elongate battery cells to improve the volumetric efficiency of batteries is being considered. However, elongate battery cells have a greater potential to warp as a result of being charged and discharged. For this reason, even a structure where a thermal contractible protection layer surrounds the outside of the electrode assembly as in the battery module disclosed in U.S. Patent Application Publication No. 2018/287184 has the potential, if the battery cells become warped, to become unable to maintain surface pressure at a constant and unable to well maintain battery performance.

### SUMMARY

In view of the above circumstances, it is an object of the present disclosure to obtain a battery module that can well maintain battery performance in a structure using elongate battery cells.

A battery module of a first aspect includes: a plurality of battery cells, each battery cell being formed by sealing, with a laminate film, an elongate electrode body; and a case in which the plurality of battery cells are housable in an arrayed state, wherein battery cells that are adjacent are adhered to each other by an adhesive, and wherein an amount of the adhesive differs between lengthwise direction central parts and end parts of the battery cells.

In the battery module of the first aspect, the battery cell is formed by sealing with the laminate film the elongate electrode body, and a plurality of the battery cells are housed in an arrayed state in the case. Here, the battery cells are adhered to each other by the adhesive, so the formation of gaps between the adjacent battery cells caused for example by warping of the battery cells can be inhibited.

Furthermore, the amount of the adhesive differs between the lengthwise direction central parts and end parts of the battery cells. Because of this, even if the battery cells become warped, variations in surface pressure between the central parts and the end parts of the battery cells can be inhibited. It will be noted that “central part” here denotes a predetermined range including the lengthwise direction center of the battery cell and for example refers to a central region of the battery cell when the battery cell is divided into three equal parts in its lengthwise direction. Furthermore, “end parts” widely includes regions excluding the central part and for example refers to regions excluding the central region when the battery cell is divided into three equal parts in its lengthwise direction.

A battery module of a second aspect is the first aspect, wherein the amount of the adhesive is greater at the end parts than at the central parts.

In the battery module of the second aspect, even if the battery cells become warped in a direction in which the end parts of the adjacent battery cells separate from each other, variations in surface pressure between the central parts and the end parts of the battery cells can be inhibited because the amount of the adhesive at the end parts is increased.

A battery module of a third aspect is the second aspect, wherein the thickness of the adhesive is thicker at the end parts than at the central parts.

In the battery module of the third aspect, variations in the surface pressure of the battery cells can be inhibited just by changing the thickness of the adhesive.

A battery module of a fourth aspect is the first aspect, wherein the amount of the adhesive is greater at the central parts than at the end parts.

In the battery module of the fourth aspect, even if the battery cells become warped in a direction in which the central parts of the adjacent battery cells separate from each other, variations in surface pressure between the central parts and the end parts of the battery cells can be inhibited because the amount of the adhesive at the central parts is increased.

A battery module of a fifth aspect is the fourth aspect, wherein the thickness of the adhesive is thicker at the central parts than at the end parts.

In the battery module of the fifth aspect, variations in the surface pressure of the battery cells can be inhibited just by changing the thickness of the adhesive.

A battery module of a sixth aspect is any one of the first aspect to the fifth aspect, wherein the battery cells and the case are adhered to each other via an adhesive.

In the battery module of the sixth aspect, the battery cells and the case are adhered to each other by the adhesive, so the restraining force acting on the battery cells from the case can be inhibited from changing with a simple structure.

A battery module of a seventh aspect is the sixth aspect, wherein recessed portions are formed in inner walls of the case where the case is adhered to the battery cells via the adhesive.

In the battery module of the seventh aspect, when the battery cells are inserted into the case, the adhesive between the battery cells and the case enters the recessed portions, whereby the adhesive can be inhibited from accumulating in the corners of the case.

A battery module of an eighth aspect is any one of the first aspect to the fifth aspect, wherein the case is provided with pressing members capable of pressing the battery cells in the array direction.

In the battery module of the eighth aspect, the pressing members press the battery cells in the array direction, so the restraining force acting on the battery cells from the case can be inhibited from changing with a simple structure.

A battery module of a ninth aspect is the eighth aspect, wherein the pressing members are configured to include leaf springs that are attached to inner walls of the case and are capable of applying urging force to the battery cells.

In the battery module of the ninth aspect, the restraining force acting on the battery cells from the case can be changed just by changing the spring constant of the leaf springs.

A battery module of a tenth aspect is the eighth aspect, wherein the pressing members are configured to include screws capable of being screwed into screw holes that pass through a wall surface of the case.

In the battery module of the tenth aspect, the restraining force on the battery cells can be changed by adjusting the tightness of the screws screwed into the screw holes.

As described above, according to the battery module pertaining to the present disclosure, battery performance can be well maintained in a structure using elongate battery cells.

### BRIEF DESCRIPTION OF THE DRAWINGS

Exemplary embodiments of the present disclosure will be described in detail based on the following figures, wherein:

FIG. 1 is a schematic plan view illustrating main parts of a vehicle to which a battery pack pertaining to a first embodiment has been applied;

FIG. 2 is a schematic perspective view of a battery module;

FIG. 3 is a plan view of the battery module in a state in which a top cover is removed;

FIG. 4 is a schematic view of a battery cell housed in the battery module as viewed from its thickness direction;

FIG. 5 is an enlarged plan view illustrating central parts of the battery cells configuring the battery module in the first embodiment;

FIG. 6 is an enlarged plan view illustrating end parts of the battery cells configuring the battery module in the first embodiment;

FIG. 7 is an enlarged plan view illustrating a part between a case and the battery cells in the battery module in the first embodiment;

FIG. 8 is a schematic planar cross-sectional view illustrating a state in which the battery cells are being inserted into the case of the battery module in the first embodiment;

FIG. 9 is a schematic planar cross-sectional view illustrating a state in which the insertion of the battery cells into the case of the battery module in the first embodiment is finished;

FIG. 10 is a schematic planar cross-sectional view illustrating a case of a battery module in a second embodiment; and

FIG. 11 is a schematic planar cross-sectional view illustrating a case of a battery module in a third embodiment.

### DETAILED DESCRIPTION

### First Embodiment

A battery module 11 pertaining to a first embodiment will now be described with reference to the drawings.

### Overall Configuration of Vehicle 100

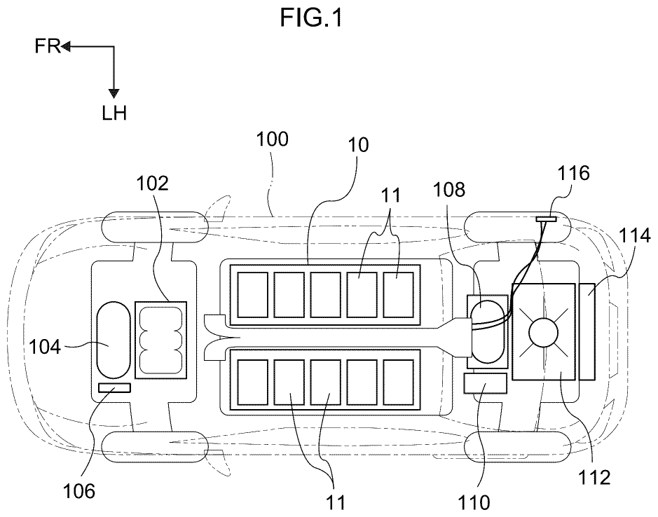

FIG. 1 is a schematic plan view illustrating main parts of a vehicle 100 to which a battery pack 10 pertaining to the present embodiment has been applied. As illustrated in FIG. 1, the vehicle 100 is a battery electric vehicle (BEV) where the battery pack 10 is installed under the floor. It will be noted that arrow UP, arrow FR, and arrow LH in the drawings indicate an upward direction in the vehicle up and down direction, a forward direction in the vehicle front and rear direction, and a leftward direction in the vehicle width direction, respectively. When description is given using the directions of front/rear, left/right, and upper/lower, unless otherwise specified these shall mean front/rear in the vehicle front and rear direction, left/right in the vehicle width direction, and upper/lower in the vehicle up and down direction.

In the vehicle 100 of the present embodiment, as an example, a DC/DC converter 102, an electric compressor 104, and a positive temperature coefficient (PTC) heater 106 are disposed on the vehicle front side of the battery pack 10. Furthermore, on the vehicle rear side of the battery pack 10, a motor 108, a gearbox 110, an inverter 112, and a charger 114 are disposed.

Direct current output from the battery pack 10 has its voltage regulated by the DC/DC converter 102 and is thereafter supplied to the electric compressor 104, the PTC heater 106, the inverter 112, and elsewhere. Furthermore, power is supplied via the inverter 112 to the motor 108, whereby rear wheels rotate and cause the vehicle 100 to travel.

A charging port 116 is provided in the right side portion of the rear portion of the vehicle 100. By connecting a charging plug of an outside charging station (not illustrated in the drawings) to the charging port 116, power can be stored in the battery pack 10 via the on-board charger 114.

It will be noted that the arrangement and structures of the parts configuring the vehicle 100 are not limited to the configurations described above. For example, the battery pack 10 may also be applied to a hybrid vehicle (HV) or a plug-in hybrid electric vehicle (PHEV) where an engine is installed. Furthermore, although in the present embodiment the vehicle to which the battery pack 10 is applied is a rear-wheel-drive vehicle where the motor 108 is installed in the rear portion of the vehicle, the vehicle to which the battery pack 10 is applied is not limited to this and may be a front-wheel-drive vehicle where the motor 108 is installed in the front portion of the vehicle or a vehicle where a pair of the motors 108 are installed in the front and rear of the vehicle. Moreover, the vehicle to which the battery pack 10 is applied may be a vehicle where each wheel has an in-wheel motor.

Here, the battery pack 10 is configured to include plural battery modules 11. In the present embodiment, as an example, the battery pack 10 is provided with ten battery modules 11. Specifically, five battery modules 11 are arrayed in the vehicle front and rear direction on the right side of the vehicle 100, and five battery modules 11 are arrayed in the vehicle front and rear direction on the left side of the vehicle 100. Furthermore, the battery modules 11 are electrically interconnected.

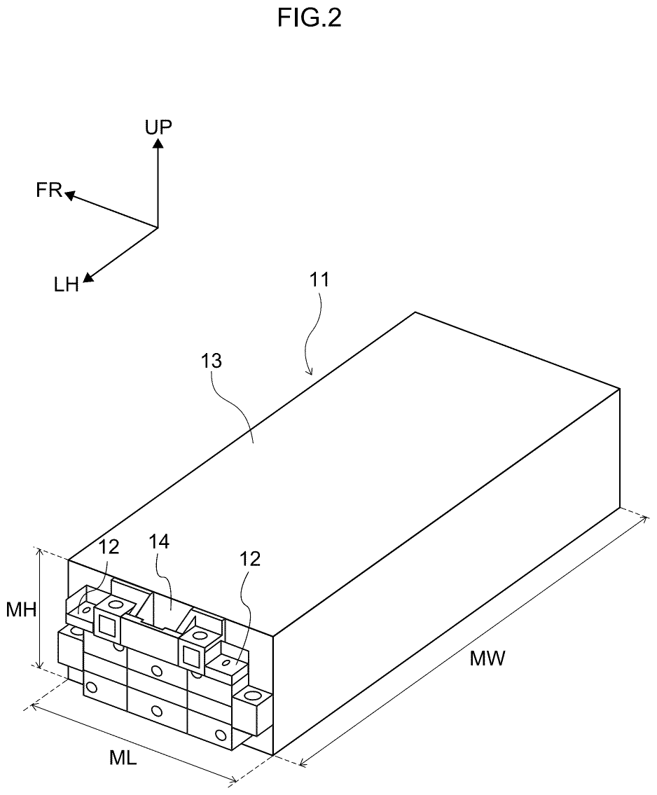

FIG. 2 is a schematic perspective view of the battery module 11. As illustrated in FIG. 2, the battery module 11 is formed substantially in the shape of a rectangular cuboid whose lengthwise direction coincides with the vehicle width direction. Furthermore, the battery module 11 has a case 13 that is formed of an aluminum alloy. The case 13 of the battery module 11 is, for example, formed by joining, by laser welding or the like, aluminum die casts to both end portions of an extruded material of aluminum alloy.

Both vehicle width direction end portions of the battery module 11 are provided with a pair of voltage terminals 12 and a connector 14. To the connectors 14 are connected a flexible printed circuit 21 described later. Furthermore, busbars (not illustrated in the drawings) are welded to both vehicle width direction end portions of the battery module 11.

The battery module 11 has a vehicle width direction length MW that is 350 mm to 600mm for example, a vehicle front and rear direction length ML that is 150 mm to 250 mm for example, and a vehicle up and down direction height MH that is 80 mm to 110 mm for example.

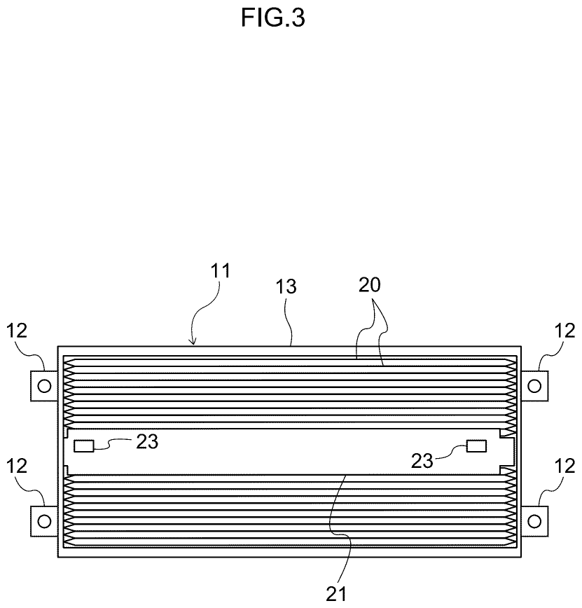

FIG. 3 is a plan view of the battery module 11 in a state in which a top cover is removed. As illustrated in FIG. 3, inside the battery module 11, plural battery cells 20 are housed in an arrayed state. In the present embodiment, as an example, twenty-four battery cells 20 are arrayed in the vehicle front and rear direction and adhered to each other.

On the battery cells 20 is disposed a flexible printed circuit (FPC) 21. The flexible printed circuit 21 is formed in the shape of a band whose lengthwise direction coincides with the vehicle width direction, and thermistors 23 are provided on both end portions of the flexible printed circuit 21. The thermistors 23 are not adhered to the battery cells 20 but are configured to be pressed toward the battery cells 20 by the top cover of the battery module 11.

Furthermore, inside the battery module 11 are housed one or plural buffer members (not illustrated in the drawings). For example, the buffer members are elastically deformable thin plate-like members and are disposed between adjacent battery cells 20 such that their thickness direction coincides with the array direction of the battery cells 20. In the present embodiment, as an example, the buffer members are disposed on both lengthwise direction end portions and in the lengthwise direction central part of the battery module 11.

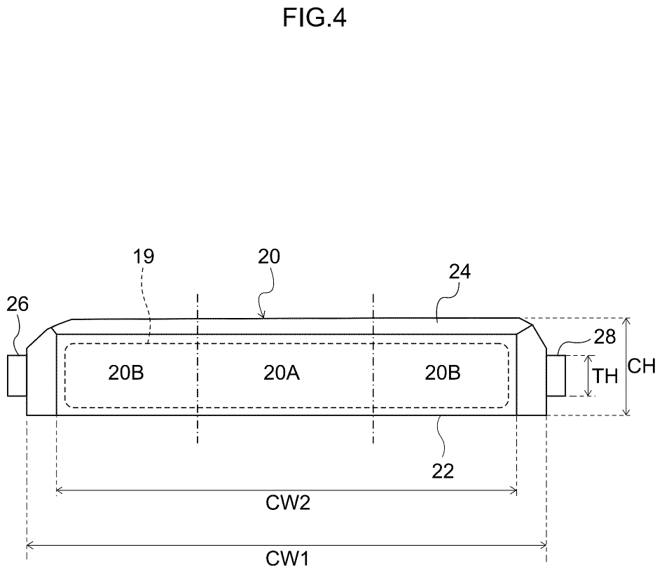

FIG. 4 is a schematic view of the battery cell 20 housed in the battery module 11 as viewed from its thickness direction. As illustrated in FIG. 4, the battery cell 20 is formed substantially in the shape of a rectangular plate, and an elongate electrode body 19 is housed inside. The electrode body 19 is configured by laminating positive electrodes, negative electrodes, and separators and is sealed by a laminate film 22.

In the present embodiment, as an example, a housing portion of the electrode body 19 is formed by folding over and bonding the laminate film 22 that is sheet-like and embossed. It will be noted that although a single cup embossed structure that is embossed in one place and a double cup embossed structure that is embossed in two places can be employed, in the present embodiment a single cup embossed structure with a draw depth of about 8 mm to 10 mm is employed.

The upper ends of both lengthwise direction end portions of the battery cell 20 are bent, and the corners form the profile. Furthermore, the upper end portion of the battery cell 20 is bent, and a fixing tape 24 is wrapped along the lengthwise direction around the upper end portion of the battery cell 20.

Here, both lengthwise direction end portions of the battery cell 20 are each provided with a terminal (tab) 26. In the present embodiment, as an example, the terminals 26 are provided in positions downwardly offset from the up and down direction center of the battery cell 20. The terminals 26 are joined by laser welding or the like to busbars (not illustrated in the drawings).

A vehicle width direction length CW1 of the battery cell 20 is 530 mm to 600 mm for example, a length CW2 of the region where the electrode body 19 is housed is 500 mm to 520 mm for example, and a height CH of the battery cell 20 is 80 mm to 110 mm for example. For this reason, the battery cell 20 is formed in an elongate shape, and the direction of lengths CW1 and CW2 coincides with its lengthwise direction.

Furthermore, the thickness of the battery cell 20 is 7.0 mm to 9.0 mm, and a height TH of the terminals 26 is 40 mm to 50 mm. It will be noted that in the following description the central region of the battery cell 20 when the battery cell 20 is divided into three equal parts in its lengthwise direction will be called a central part 20A and the regions on both sides of the central part 20A will be called end parts 20B.

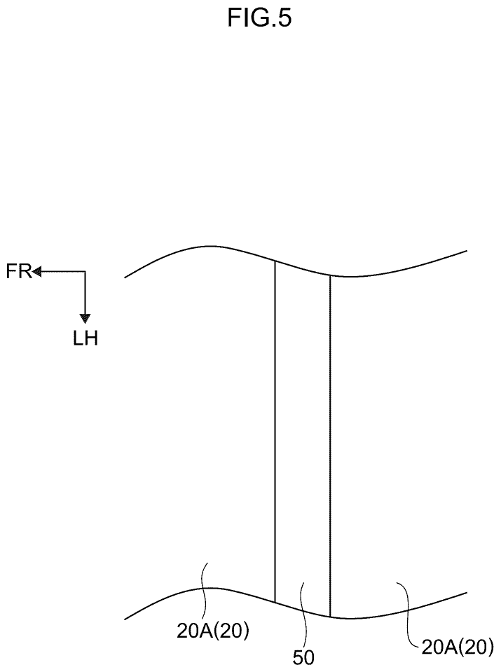

FIG. 5 is an enlarged plan view illustrating the central parts 20A of the battery cells 20 configuring the battery module 11 in the present embodiment. As illustrated in FIG. 5, an adhesive 50 is provided between the battery cells 20 that are adjacent, and the battery cells 50 that are adjacent are adhered to each other by the adhesive 50. The type of the adhesive 50 is not particularly limited, and for example an acrylic resin adhesive, a urethane resin adhesive, an epoxy resin adhesive, and a silicone resin adhesive may be used.

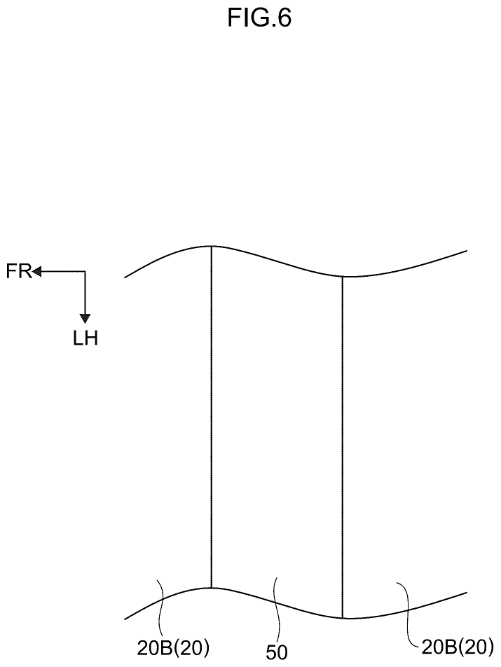

FIG. 6 is an enlarged plan view illustrating the end parts 20B of the battery cells 20 in the present embodiment. As illustrated in FIG. 6, at the end parts 20B also, the adhesive 50 is provided between the battery cells 20 that are adjacent, and the battery cells 20 that are adjacent are adhered to each other by the adhesive 50. Here, in the present embodiment, the amount of the adhesive 50 differs between the lengthwise direction central parts 20A and end parts 20B of the battery cells 20. Specifically, in the present embodiment, the thickness of the adhesive 50 is thicker at the end parts 20B than at the central parts 20A of the battery cells 20. In other words, the amount of the adhesive 50 is greater at the end parts 20B than at the central parts 20A of the battery cells 20.

It will be noted that “the adhesive 50 is thicker at the end parts 20B than at the central parts 20A of the battery cells 20” means for example that the average thickness of the adhesive 50 at the end parts 20B of the battery cells 20 is thicker than the average thickness of the adhesive 50 at the central parts 20A. Furthermore, even if the thicknesses of the adhesive 50 at the central parts 20A and the end parts 20B are substantially the same, in a case where the amount of the adhesive 50 provided at the entire end parts 20B is greater than the amount of the adhesive 50 provided at the entire central parts 20A, “the amount of the adhesive 50 is greater at the end parts 20B than at the central parts 20A of the battery cells 20” obtains.

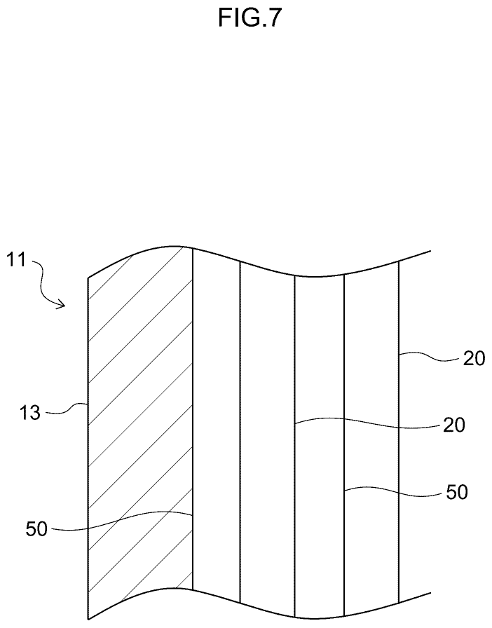

FIG. 7 is an enlarged plan view illustrating a part between the case 13 and the battery cells 20 in the battery module 11 in the present embodiment. As illustrated in FIG. 7, the adhesive 50 is provided between the battery cells 20 disposed on the outermost end portions and the case 13, and the battery cells 20 and the case 13 are adhered to each other via the adhesive 50. In the present embodiment, the same adhesive is used for the adhesive 50 adhering the battery cells 20 and the case 13 to each other and the adhesive 50 adhering the battery cells 20 to each other, but the disclosure is not limited to this, and different adhesives may be used. It will be noted that in FIG. 7 the thickness of the adhesive 50 is exaggerated for convenience of description and differs from the actual thickness.

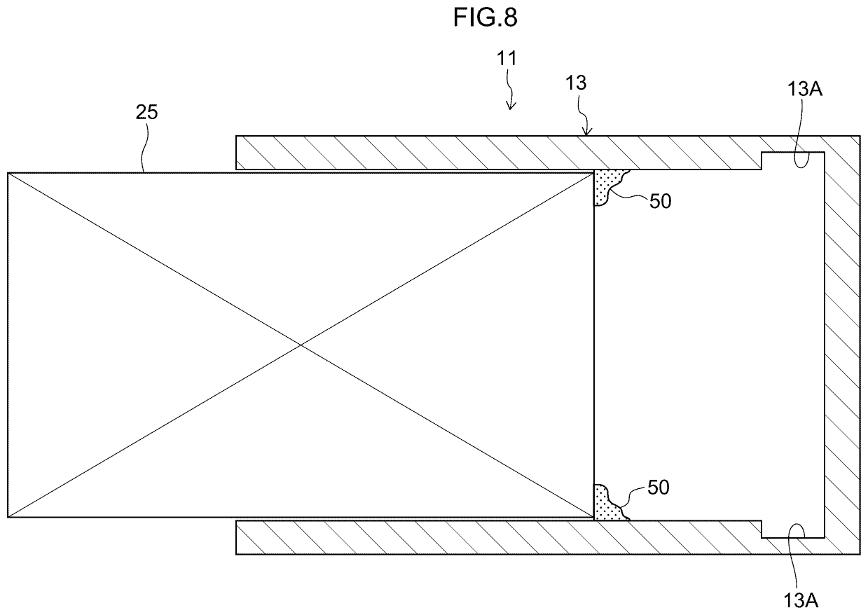

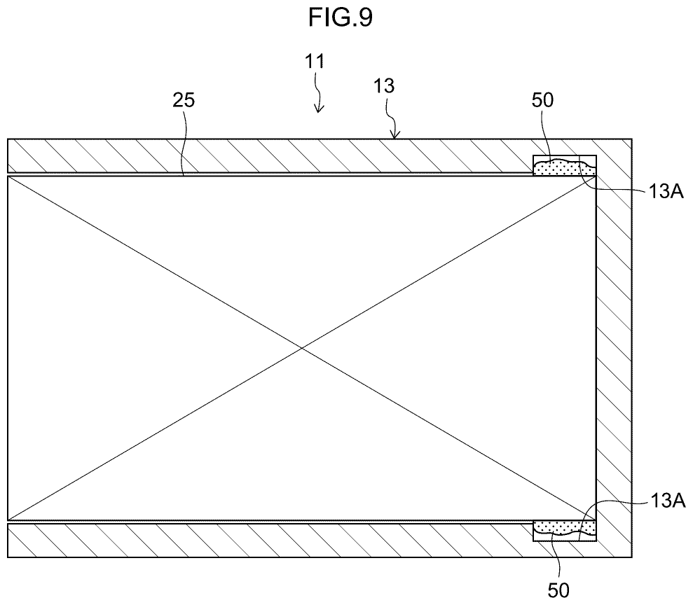

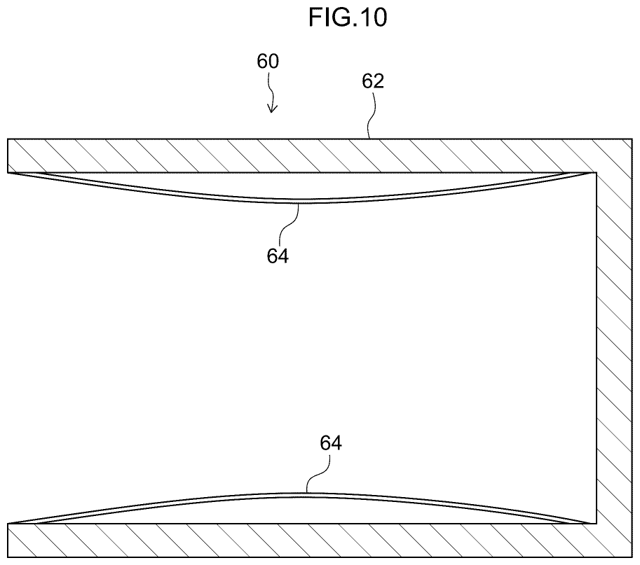

FIG. 8 is a schematic planar cross-sectional view illustrating a state in which the battery cells 20 are being inserted into the case 13 of the battery module 11 in the present embodiment. It will be noted that although FIG. 8 illustrates a state in which a top portion of the case 13 is removed, in reality the case 13 is formed in the shape of a tube that also includes a top portion. Furthermore, for convenience of description, FIG. 8, FIG. 9, and FIG. 10 show as one battery cell group 25 the plural battery cells 20 in which the twenty-four battery cells 20 are arrayed in the vehicle front and rear direction and adhered to each other.

As illustrated in FIG. 8, recessed portions 13A are formed in inner walls of the case 13. The inner walls in which the recessed portions 13A are formed are inner walls where the battery cells 20 and the case 13 are adhered to each other via the adhesive 50.

Here, when the battery module 11 is manufactured, the battery cell group 25 is inserted into the case 13 in a state in which the adhesive 50 has been applied to at least one of the battery cell group 25 and the inner walls of the case 13. At this time, some of the adhesive 50 between the battery cell group 25 and the case 13 sticks to the end portion of the battery cell group 25.

As illustrated in FIG. 9, in a state in which the insertion of the battery cell group 25 into the case 13 is finished, excess adhesive 50 enters the recessed portions 13A, whereby the amount of the adhesive 50 between the case 13 and the battery cell group 25 becomes substantially uniform.

### Action

Next, the action of the battery module 11 pertaining to the present embodiment will be described.

In the battery module 11 pertaining to the present embodiment, the battery cell 20 is formed by sealing with the laminate film 22 the elongate electrode body 19, and a plurality of the battery cells 20 are housed in an arrayed state in the case 13. Here, as illustrated in FIG. 5 and FIG. 6, the battery cells 20 are adhered to each other by the adhesive 50, so the formation of gaps between the adjacent battery cells 20 caused for example by warping of the battery cells 20 can be inhibited.

Furthermore, the amount of the adhesive 50 differs between the lengthwise direction central parts 20A and end parts 20B of the battery cells 20. Because of this, even if the battery cells 20 become warped, variations in surface pressure between the central parts 20A and the end parts 20B of the battery cells 20 can be inhibited. As a result, battery performance can be well maintained in a structure using the elongate battery cells 20.

In particular, in the present embodiment, the amount of the adhesive 50 is greater and the thickness of the adhesive 50 is thicker at the end parts 20B than at the central parts 20A of the battery cells 20. Because of this, even if the battery cells 20 become warped in a direction in which the end parts of the adjacent battery cells 20 separate from each other, variations in surface pressure between the central parts 20A and the end parts 20B of the battery cells 20 can be inhibited because the amount of the adhesive 50 at the end parts 20B is increased.

Furthermore, in the present embodiment, as illustrated in FIG. 7, the battery cells 20 and the case 13 are adhered to each other by the adhesive 50, so the restraining force acting on the battery cells 20 from the case 13 can be inhibited from changing with a simple structure.

Moreover, in the present embodiment, as illustrated in FIG. 8 and FIG. 9, when the battery cell group 25 is inserted into the case 13, the adhesive 50 between the battery cell group 25 and the case 13 enters the recessed portions 13A formed in the case 13, whereby the adhesive 50 can be inhibited from accumulating in the corners of the case 13. Because of this, the insertion of the battery cell group 25 can be effectively inhibited from being obstructed by the adhesive 50.

### Second Embodiment

Next, a battery module 60 pertaining to a second embodiment will be described with reference to FIG. 10. It will be noted that configurations that are the same as those of the first embodiment are assigned the same reference signs and detailed description thereof will be omitted.

FIG. 10 is a schematic planar cross-sectional view illustrating a case 62 of the battery module 60 in the second embodiment. As illustrated in FIG. 10, the case 62 pertaining to the present embodiment differs from the case 13 of the first embodiment in that it does not have the recessed portions 13A formed in it. Furthermore, the case 62 is substantially the same size as the case 13 of the first embodiment.

Here, in the present embodiment, the case 62 is provided with leaf springs 64 serving as pressing members capable of pressing the battery cell group in the array direction. The leaf springs 64 are attached to inner walls of the case 62 and are configured to be capable of applying urging force to the battery cell group.

Specifically, the leaf springs 64 are attached to mutually opposing wall surfaces in the case 62 and project in the direction in which they oppose each other. For this reason, in a state in which the battery cell group has been inserted into the case 62, the battery cell group is pressed from both sides by the leaf springs 64.

### Action

Next, the action of the battery module 60 pertaining to the present embodiment will be described.

In the present embodiment, the leaf springs 64 press the battery cell group, so the restraining force acting on the battery cells from the case 62 can be inhibited from changing with a simple structure. In particular, the restraining force acting on the battery cells from the case 62 can be changed just by changing the spring constant of the leaf springs 64.

Furthermore, in the present embodiment, the battery cell group can be inhibited from moving inside the case 62 without the intervention of an adhesive between the case 62 and the battery cell group. Other actions are the same as those of the first embodiment.

### Third Embodiment

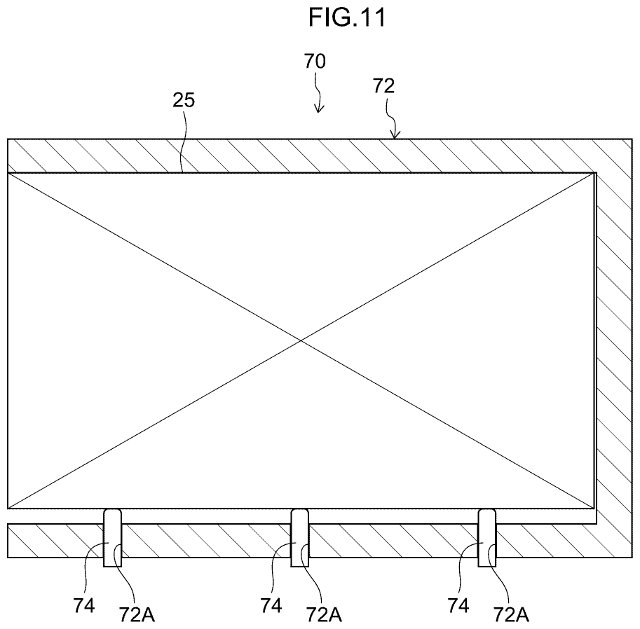

Next, a battery module 70 pertaining to a third embodiment will be described with reference to FIG. 11. It will be noted that configurations that are the same as those of the first embodiment are assigned the same reference signs and detailed description thereof will be omitted.

FIG. 11 is a schematic planar cross-sectional view illustrating a case 72 of the battery module 70 in the second embodiment. As illustrated in FIG. 11, the case 72 pertaining to the present embodiment differs from the case 13 of the first embodiment in that it does not have the recessed portions 13A formed in it. Furthermore, the case 72 is substantially the same size as the case 13 of the first embodiment.

Here, in the present embodiment, plural screw holes 72A are formed in one side wall of the case 72. In the present embodiment, as an example, three screw holes 72A are formed. For example, the three screw holes 72A are formed equidistantly from each other.

The screw holes 72A are formed so as to pass through the side wall of the case 72. Furthermore, screws 74 serving as pressing members are screwed into the screw holes 72A. The screws 74 are headless set screws and are configured to be able to press the battery cell group 25 inside the case 72 toward the opposing wall surface side as a result of being screwed into the screw holes 72A.

### Action

Next, the action of the battery module 70 pertaining to the present embodiment will be described.

In the present embodiment, the restraining force on the battery cells 20 can be changed by adjusting the tightness of the screws 74 screwed into the screw holes 72A. Other actions are the same as those of the first embodiment.

Although battery modules 11, 60, 70 pertaining to embodiments have been described above, the disclosure is not limited to this and can of course be implemented in various aspects without departing from the spirit of the disclosure. For example, although in the first embodiment the thickness of the adhesive 50 is thicker at the end parts 20B than at the central parts 20A of the battery cells 20 as illustrated in FIG. 5 and FIG. 6, the disclosure is not limited to this, and the thickness of the adhesive 50 may be thicker at the central parts 20A than at the end parts 20B. In this case, even if the battery cells 20 become warped in a direction in which the central parts 20A of the adjacent battery cells 20 separate from each other, variations in surface pressure between the central parts 20A and the end parts 20B of the battery cells 20 can be inhibited because the amount of the adhesive at the central parts 20A is increased.

Furthermore, the adhesive 50 need not be provided on the entireties of the battery cells 20. Namely, the battery cells 20 may have regions not provided with the adhesive 50.

Moreover, although in the first embodiment the adhesive 50 is provided between the case 13 and the battery cell group 25, the disclosure is not limited to this, and the adhesive 50 need not be provided there. For example, in a case where there is no gap between the case 13 and the battery cell group 25, variations in surface pressure can be inhibited even without adhering them with the adhesive 50.

The following supplementary notes are disclosed in relation to the above embodiments.

### Supplementary Note 1

A battery module comprising:
a plurality of battery cells, each battery cell being formed by sealing, with a laminate film, an elongate electrode body; and
a case in which the plurality of the battery cells are housable in an arrayed state,
wherein the battery cells that are adjacent are adhered to each other by an adhesive, and
the amount of the adhesive differs between lengthwise direction central parts and end parts of the battery cells.

### Supplementary Note 2

The battery module of supplementary note 1, wherein the amount of the adhesive is greater at the end parts than at the central parts.

### Supplementary Note 3

The battery module of supplementary note 1 or 2, wherein the thickness of the adhesive is thicker at the end parts than at the central parts.

### Supplementary Note 4

The battery module of supplementary note 1, wherein the amount of the adhesive is greater at the central parts than at the end parts.

### Supplementary Note 5

The battery module of supplementary note 1 or 4, wherein the thickness of the adhesive is thicker at the central parts than at the end parts.

### Supplementary Note 6

The battery module of any one of supplementary notes 1 to 5, wherein the battery cells and the case are adhered to each other via an adhesive.

### Supplementary Note 7

The battery module of supplementary note 6, wherein recessed portions are formed in inner walls of the case where the case is adhered to the battery cells via the adhesive.

### Supplementary Note 8

The battery module of any one of supplementary notes 1 to 5, wherein the case is provided with pressing members capable of pressing the battery cells in the array direction.

### Supplementary Note 9

The battery module of supplementary note 8, wherein the pressing members are configured to include leaf springs that are attached to inner walls of the case and are capable of applying urging force to the battery cells.

### Supplementary Note 10

The battery module of supplementary note 8, wherein the pressing members are configured to include screws capable of being screwed into screw holes that pass through a wall surface of the case.

What is claimed is:

1. A battery module comprising:
a plurality of battery cells, each battery cell being formed by sealing, with a laminate film, an elongate electrode body; and
a case in which the plurality of battery cells are housable in an arrayed state,
wherein battery cells that are adjacent are adhered to each other by an adhesive, and
wherein an amount of the adhesive differs between lengthwise direction central parts and end parts of the battery cells.

2. The battery module of claim 1, wherein the amount of the adhesive is greater at the end parts than at the central parts.

3. The battery module of claim 2, wherein a thickness of the adhesive is thicker at the end parts than at the central parts.

4. The battery module of claim 1, wherein the amount of the adhesive is greater at the central parts than at the end parts.

5. The battery module of claim 4, wherein a thickness of the adhesive is thicker at the central parts than at the end parts.

6. The battery module of claim 1, wherein the battery cells and the case are adhered to each other via an adhesive.

7. The battery module of claim 6, wherein recessed portions are formed in inner walls of the case where the case is adhered to the battery cells via the adhesive.

8. The battery module of claim 1, wherein the case is provided with pressing members capable of pressing the battery cells in an array direction.

9. The battery module of claim 8, wherein the pressing members are configured to include leaf springs that are attached to inner walls of the case and that are capable of applying urging force to the battery cells.

10. The battery module of claim 8, wherein the pressing members are configured to include screws capable of being screwed into screw holes that pass through a wall surface of the case.
